(19) United States
(12) Patent Application Publication
(10) Pub. No.: US 2021/0368259 A1
(43) Pub. Date: Nov. 25, 2021

(54) Architectural Speaker Tuning System

(71) Applicant: Edward Avalos, Colfax, CA (US)

(72) Inventor: Edward Avalos, Colfax, CA (US)

(21) Appl. No.: 16/879,266

(22) Filed: May 20, 2020

(51) Int. Cl. H04R 1/28

(52) U.S. Cl. CPC H04R 1/2888; H04R 2201/021; H04R 1/288

(57) ABSTRACT

The Architectural Speaker Tuning System is a sand-filled plastic reinforcing sub-baffle for an architectural custom installed loudspeaker mounted in drywall paneling. The mechanical acoustical resonance of the drywall distorts the sound of the custom loudspeaker. The speaker tuning system shifts drywall resonance to a more suitable frequency. The sand-tuned result revives the fidelity of the loudspeaker. The sub-baffle shipped empty, filled with sand provided by the installer, installs through the loudspeaker drywall panel cut-put, and adheres to the rear of the drywall. The custom loudspeaker is then inserted and clamped to the sub-baffle system.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The architectural loudspeaker industry offers an abundance of acoustical and mechanical solutions. The Architectural Speaker Tuning System is a solution that addresses the corrupted phase and distorted frequency response generated by an architectural custom installed loudspeaker mounted in drywall paneling. It also tackles associated installation and shipping issues. The following patents cover associated topics:
U.S. Pat. Nos. 7,032,708B2 and 7,540,460B2 address speaker mounting and vibration.
JPS594400A addresses speaker mounting fixtures.
U.S. Pat. No. 8,985,268B2, JPH0511682U, and GB1426568 address the use of sand in speaker cabinets.

### BRIEF SUMMARY OF THE INVENTION

The Architectural Speaker Tuning System is a sand-filled reinforcing sub-baffle for a custom installed loudspeaker mounted in drywall paneling. The resonant frequency of the drywall distorts the sound of the custom loudspeaker. The Architectural Speaker Tuning System shifts distorting drywall resonance to a more suitable frequency. The sand-tuned result revives the fidelity of the loudspeaker. The speaker tuning system sub-baffle is shipped empty, filled with sand provided by the installer, and installed through the custom loudspeaker drywall cut-out. The custom loudspeaker is then inserted and clamped to the sub-baffle system.

### BRIEF DESCRIPTION OF THE SEVERAL VIEWS OF THE DRAWING

FIG. 1A Drawing of the in-ceiling sub-baffle system.

FIG. 1B Drawing of the in-ceiling sub-baffle hull.

FIG. 1C Photo of the in-ceiling sub-baffle system.

FIG. 2A Drawing of the in-wall sub-baffle system.

FIG. 2B Drawing of the in-wall sub-baffle hull.

FIG. 2C Photo of the in-wall sub-baffle system.

FIG. 3A Graph of the audio measurements without the sub-baffle.

FIG. 3B Graph of the audio measurements with the sub-baffle.

FIG. 4 Architectural Speaker Tuning System installation sketch.

### DETAILED DESCRIPTION OF THE INVENTION

The management of resonance is an essential element of loudspeaker engineering. Loudspeaker resonance is the mechanical-acoustical vibration of a frequency produced in response to an identical stimulus frequency. Undesired resonance audibly distorts the phase and the frequency response of a loudspeaker system.

Mounting a loudspeaker to a rigid loudspeaker cabinet baffle is the initial fundamental method of managing loudspeaker system resonance. Utilizing a rigid cabinet baffle for a custom in-wall or in-ceiling loudspeaker installation is typically avoided due to cost. A common compromised practice is to install the custom loudspeaker into drywall paneling. However, the resonance of the drywall paneling audibly distorts the phase and the frequency response of the loudspeaker system.

The Architectural Speaker Tuning System offers an alternative that confronts three issues:
1. The resonance of drywall distorts the sound of an architectural custom installed loudspeaker mounted in drywall paneling.
2. Obstructed access to the rear of a wall or ceiling increases installation time and cost.
3. The primary element of shipping costs is weight. Shipping cost significantly affects product pricing.

The Architectural Speaker Tuning System is a sand-filled plastic reinforcing sub-baffle for an architectural custom installed loudspeaker mounted in drywall paneling. Manufacturing the system plastic sub-baffle can employ vacuum molding, injection molding, or 3D printing.

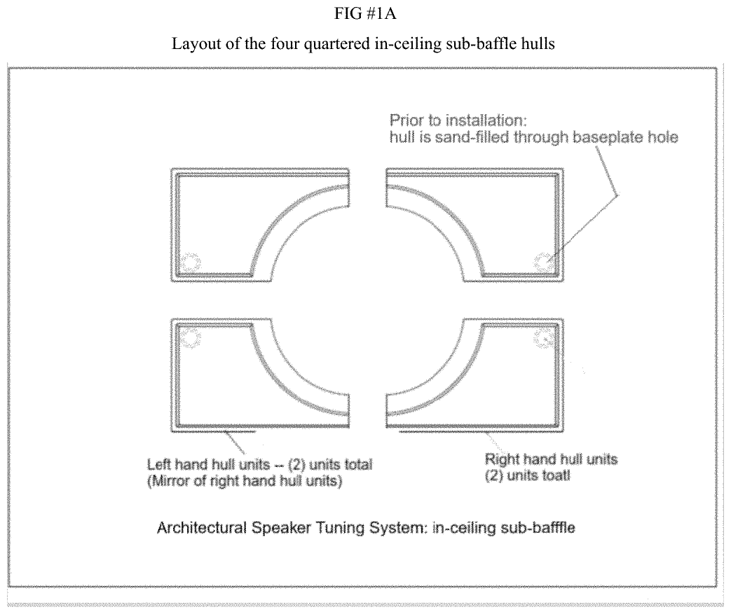

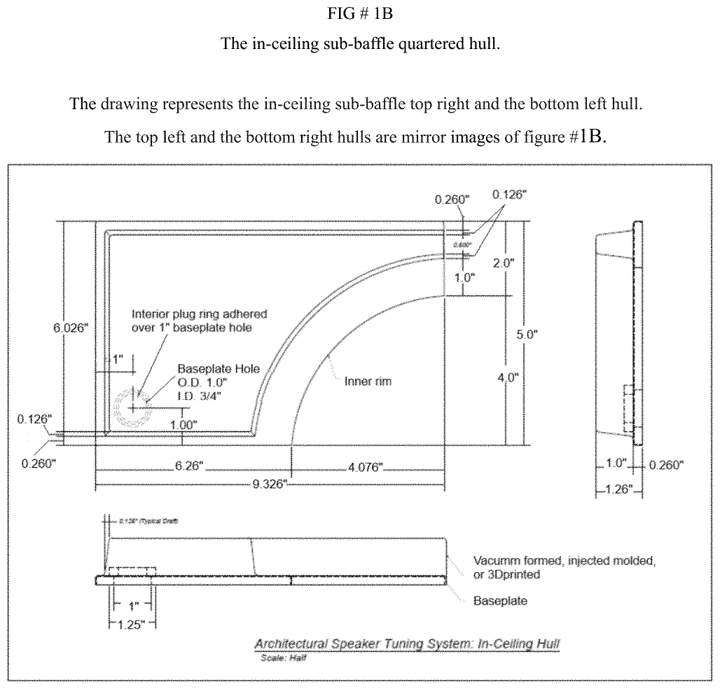

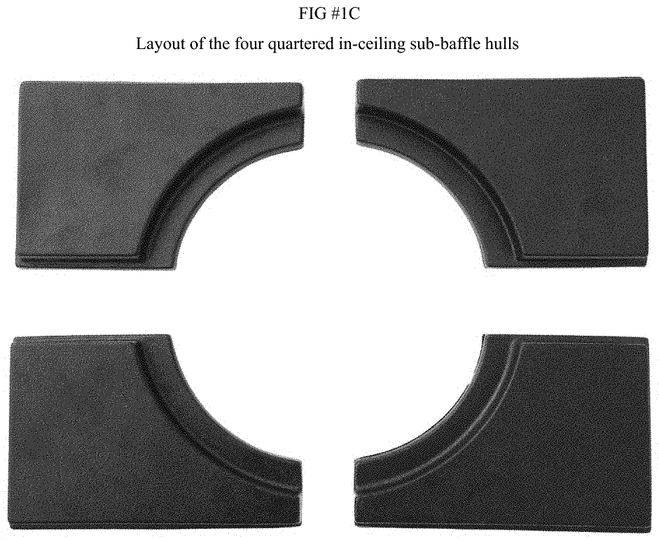

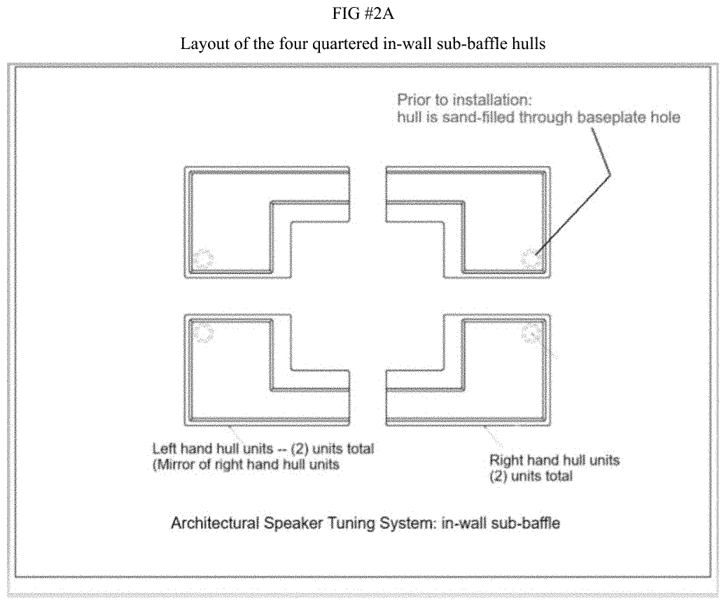

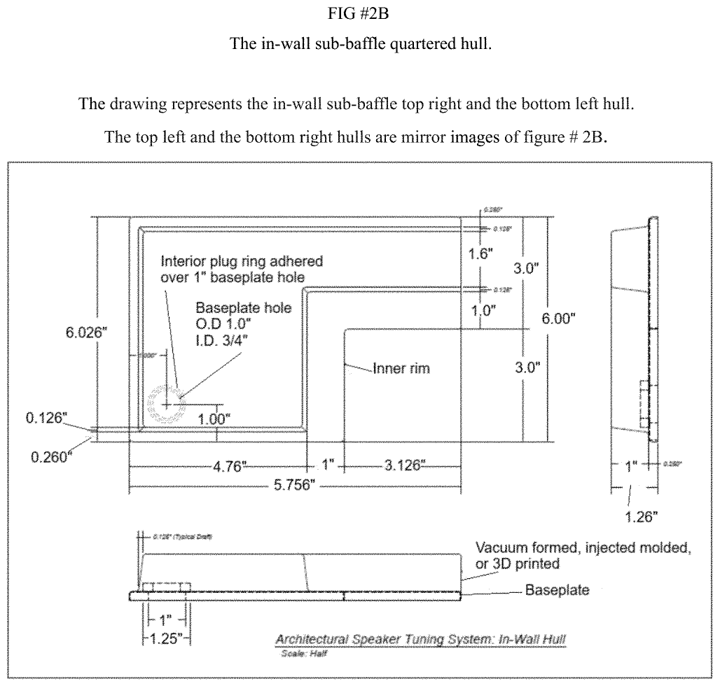

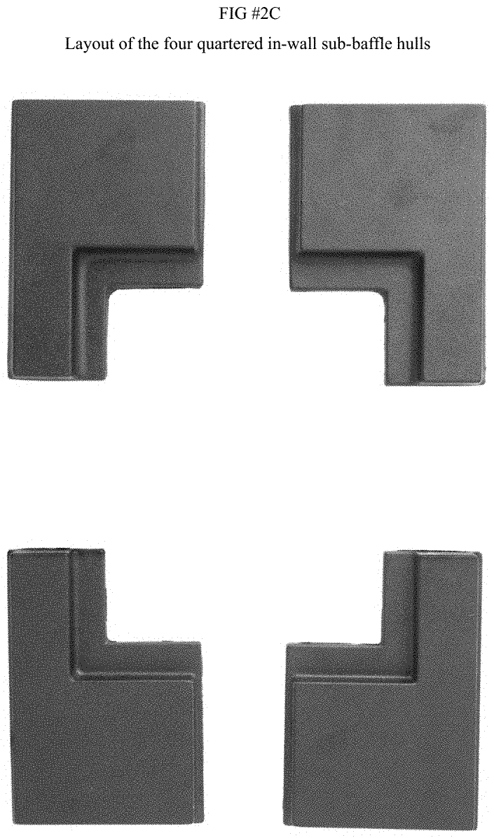

The speaker tuning system sub-baffle comprises two versions: the in-ceiling model (FIG. 1A) and the in-wall model (FIG. 2A). Both versions are quartered and manufactured as four hollow plastic hulls (FIG. 1B, 2B). The hulls are shipped empty and filled with sand provided by the installer via the interior base plate plug-ring-hole shown in FIGS. 1B and 2B. The plug ring seals the hull.

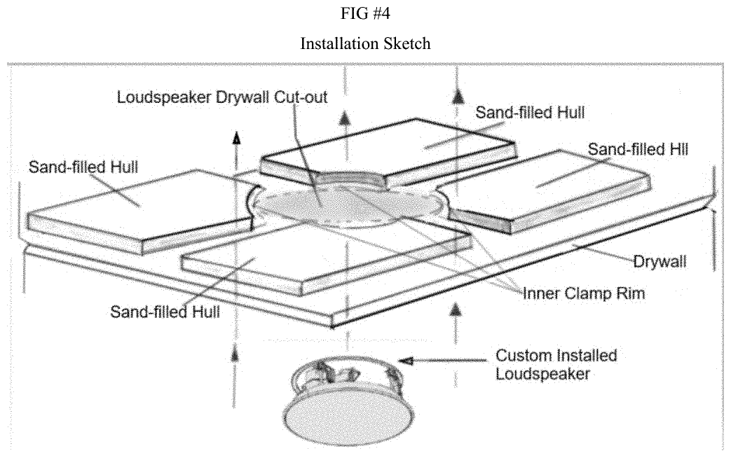

The four sand-filled plastic hulls install through a custom loudspeaker drywall panel cut-out held in place on the rear of the drywall with an adhesive. The custom speaker is then inserted and clamped to the inner rim of the sub-baffle (FIG. 4).

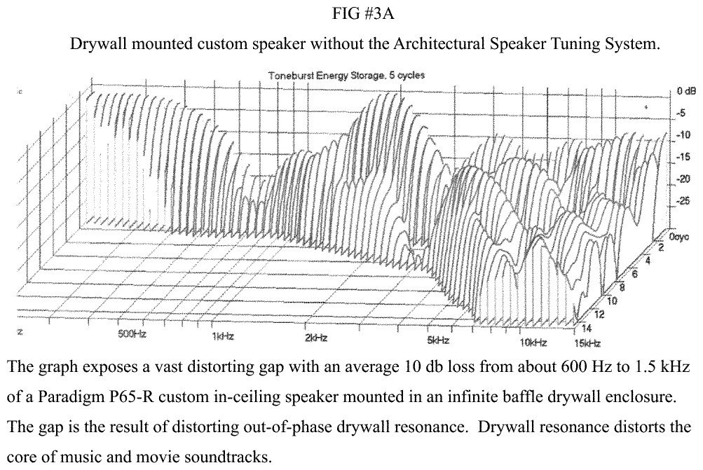

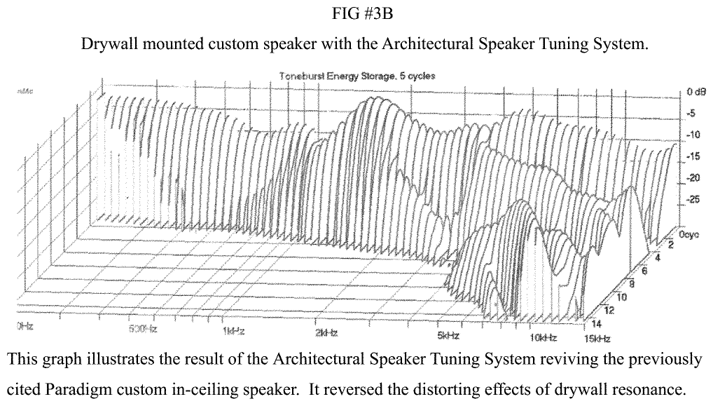

The mass-loaded-sand revives the fidelity of the custom installed loudspeaker as it re-tunes distorting drywall panel resonance to a more suitable frequency (FIG. 3A, 3B). Easy access provided by quartering the sub-baffle minimizes installation time and cost (FIG. 4). The ‘ship-empty and fill with sand provided by the installer’ element significantly reduces shipping cost and system pricing.

1. The Architectural Speaker Tuning System is an apparatus to manage the resonance of an architectural custom installed loudspeaker mounted in drywall paneling comprised of: a plastic loudspeaker sub-baffle; quartered and manufactured as four hollow plastic hulls; filled with sand; installed through a custom installed loudspeaker drywall cut-out which accommodates inserting and clamping the custom loudspeaker to the sub-baffle.
